(19) United States
(12) Patent Application Publication
(10) Pub. No.: US 2005/0113943 A1
(43) Pub. Date: May 26, 2005

(54) Wireless network controller communicating with household appliances

(75) Inventor: Zhi-Heng Nian, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 10/740,679

(22) Filed: Dec. 22, 2003

(30) Foreign Application Priority Data
Nov. 25, 2003 (TW) 92133096

(51) Int. Cl. G06F 17/00; G05B 15/00

(52) U.S. Cl. 700/83; 700/90

(57) ABSTRACT

A wireless network controller for communicating with household appliances includes a first control unit for generating at least one data packet that complies with a standard wireless network communication protocol, and a second control unit coupled to the household appliance which receives the data packet. According to the data packet, the second control unit will generate and forward a control command to control the operation of the household appliance.

### BACKGROUND OF THE INVENTION

1. Field of the Invention

The present invention relates to a wireless controller for communicating with household appliances, and in particular, to a wireless controller that can be used to communicate with household appliances via a wireless network.

2. Description of the Prior Art

There are two different ways to transmit data or communicate through a network environment. The first way is wired communication with a cable or the like, and the second is wireless communication with an infrared ray, radio frequency, or the like. However, because of its convenience in installation and mobility in use, wireless communication is booming enormously. The wireless network can be further classified according to its range in transmitting data. Examples of wireless networks classified by range include a wireless wide area network WWAN, a wireless local area network (WLAN), and a wireless personal area network (WPAN). The WLAN is a network which can transmit over a range of about on hundred meters, and that is mainly applied to a single building or in an office. In practical use, WLANs adopt an Access Point to combine with a wired network so as to promote flexibility in use and enlarge the range in transmitting. WLANs are now largely subject to standards promulgated by the institute of electrical and electronic engineers (IEEE), which has introduced several wireless communication protocols, such as 802.11 serial, HIPERLAN, HOMERF and 1394 . . . etc. An ad-hoc mode and an infrastructure mode are further defined in the 802.11 serial protocol. The ad hoc mode refers to peer-to-peer (computer to computer or computer to device) wireless communication, while the infrastructure mode refers to wireless communication between a wired network and a wireless network via an access point. Present household appliances usually use an infrared ray to control the operation of a single appliance. Such infrared controllers are convenient and not costly, but unfortunately different brand name products have their own channels to prevent interference therebetween. In addition, several telephone controlled household appliances have been introduced to the market recently, which use the DTMF tones generated by the telephone keypad to represent different operations, such as ON and OFF. However, the household appliance must still be in wired connection with the telephone. One telephone is usually predetermined to control one single household appliance.

Some makers endow appliances with the ability to go online and search useful information from the Internet. However, these are not wirelessly controlled appliances, and a user has to go directly to the appliance control panel to set up the operation of the appliances.

On the other hand, the present wireless control involves a “one-way” communication, but a user cannot observe the detail or progress of the internal variation of the operation for the appliance.

### SUMMARY OF THE DISCLOSURE

It is an objective of the present invention to provide a wireless network controller that enables a user to control at least a household appliance.

It is another object of the present invention to provide a wireless network controller capable of two-way communications.

To accomplish the advantages described above, a wireless network controller constructed in accordance with the principles of a preferred embodiment of the invention includes a first control unit, and at least a household appliance with a second control unit. A user operates the first control unit to generate a first control signal, which is further formatted into a data packet that complies with the standard wireless network communication protocol, and then the data packet is transmitted to the second control unit, so as to control the operation of the household appliance.

### BRIEF DESCRIPTION OF THE DRAWINGS

FIG. 1 is a block diagram of a first controller according to the present invention.

FIG. 2 is a block diagram of a second controller coupled to a household appliance.

FIG. 3 is a first embodiment according to the present invention.

FIG. 4 is a second embodiment according to the present invention.

FIG. 5 is a third embodiment according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

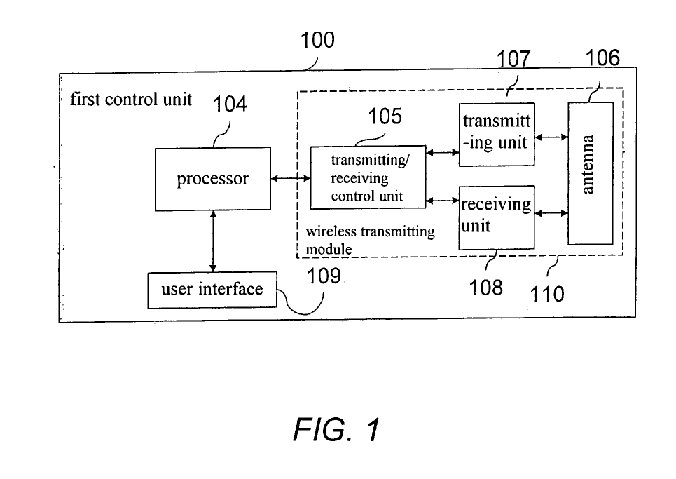

Referring to FIG. 1, the first control unit 100 comprises a user interface 109, a processor 104, and a wireless transmitting module 110. A user may operate the interface 109 to generate a control signal which is further processed by the processor 104. The control signal is formatted into one or more data packets to comply with the standard wireless network communication protocol, and then transmitted by the wireless transmitting module 110. The wireless transmitting module 110 includes a transmitting/receiving unit 105 for supply data to and receiving data from a respective transmitting unit 107 and a receiving unit 108. The transmitting and receiving units are in turn connected to an antenna or antenna unit 106. The transmitting/receiving unit 105 can control the units 107 and 106 for sending signals, and the units 108 and 106 for receiving signals.

A suitable wireless network communication protocol is the 802.11 serial protocol standard, but those skilled in the art will appreciate that the invention is not limited to a particular standard enacted by the IEEE.

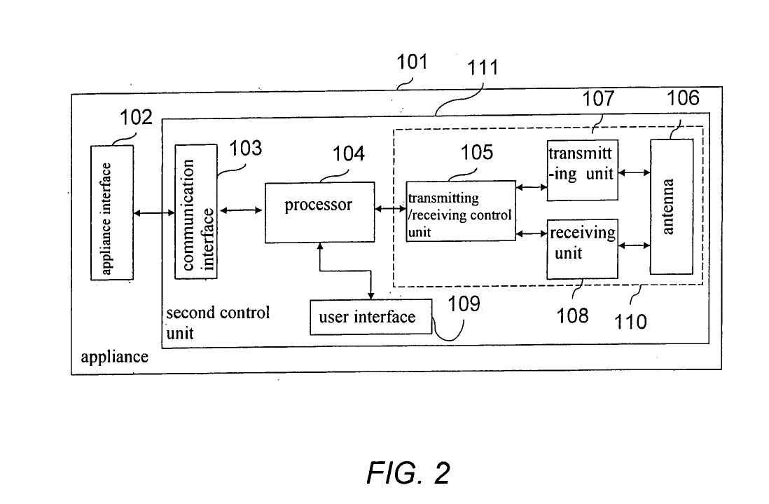

Referring to FIG. 2, the second control unit 111 comprises a user interface 109, a processor 104, a household appliance communication interface 103, and a wireless transmitting module 110. In this figure, elements that are also included in the first control unit of FIG. 1 have been given the same reference numerals even though the common elements might not be exactly identical.

The communication interface 103 of the second control unit 111 connects the household appliance 101 to the second control unit 111 via a control interface 102 on the household appliance. In addition, the transmitting module 110 receives one or more data packets sent from the first control unit 100, and forwards it to the processor 104 as to decode the data packets and generate a control command to control the operation of the household appliance 101. However, a user may directly operate the interface 109 to generate the first control signal to the processor 104 so as to output the control command through the interface 103 to the interface 102 to control the operation of the household appliance 101.

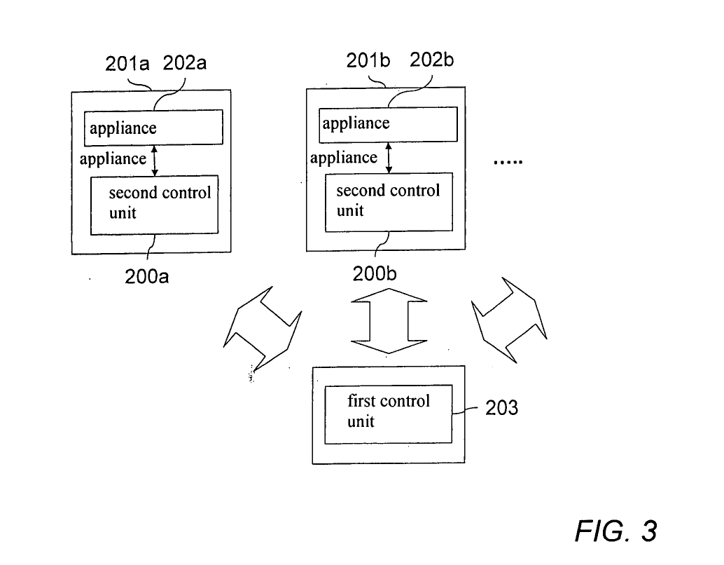

FIG. 3 shows a first embodiment according to the present invention.

The second control units 201a, 201b are respectively coupled to (or built-in) the household appliances 200a, 200b through interfaces 202a, 202b. A user may use the first control unit 203 to control the operation of the household appliances 201a and 201b when the user operates the interface 109, such as a button, a touch pad . . . etc., to generate a control signal. Further, the processor 104 will format the control signal into one or more data packets which comply with a standard wireless network communication protocol, and the wireless transmitting module 110 will send the data packet(s) to the household appliance 201a or 201b.

For example, if the wireless transmitting module 110 of the second control unit 200a coupled to the household appliance 201a receives a data packet(s), the processor 104 of the second control unit 200a will decode the data packet into a control command to control the operation of the household appliance 201a. Please notice that the communication between the first control, and second control unit 203 and 200a adopts an ad-hoc (peer-to-peer) mode.

On the other hand, because the wireless network is a two-way communication system, the second control unit 200a (200b), can receive a feedback signal generated from the household appliance 201a (201b), and forward the feedback signal to the first control unit 203 via the wireless transmitting module 110 of the second control unit 200a (200b). If the interface 109 of the first control unit is a touch pad-like device, the feedback signal will be displayed on the interface 109 to show operation information, such as the temperature, channels, estimated running time . . . etc..

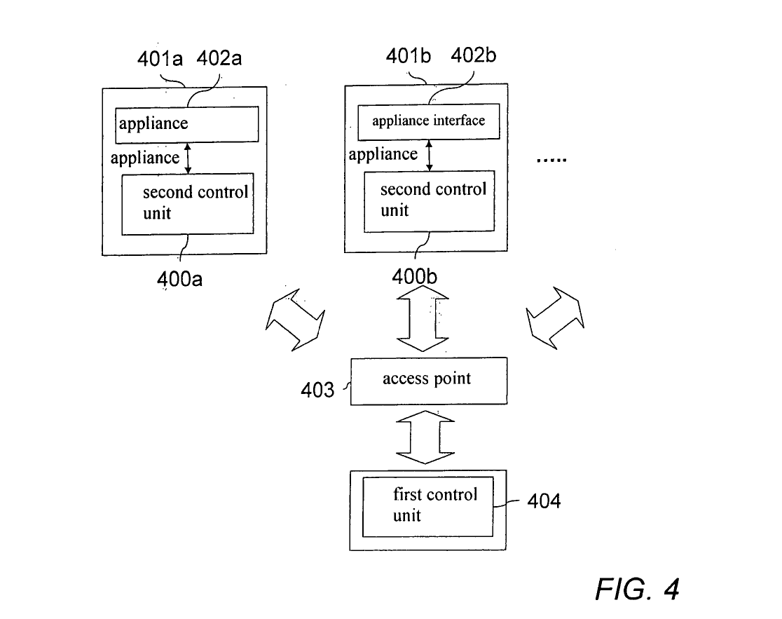

Referring to FIG. 4, in the second embodiment according to the invention, a user may use the first control unit 404 to control the operation of the household appliances 401a and/or 401b, when the user operates the interface 109, such as a button, a touch pad . . . etc., to generate a control signal. Further, the processor 104 of the first control unit 404 will format the control signal into one or more data packets which comply with the standard wireless network communication protocol, and the wireless transmitting module 110 of the first control unit 404 will send the data packet(s) to a household appliance 401a (401b) via interface 402a (402b) and the second control unit 400a (400b) via an access point 403. Please notice that the communication between the first control and second control unit 404 and 403 adopts an infrastructure mode (wireless-to-wired) due to the relatively far distance between the first control unit 404 and the household appliance 401a(401b).

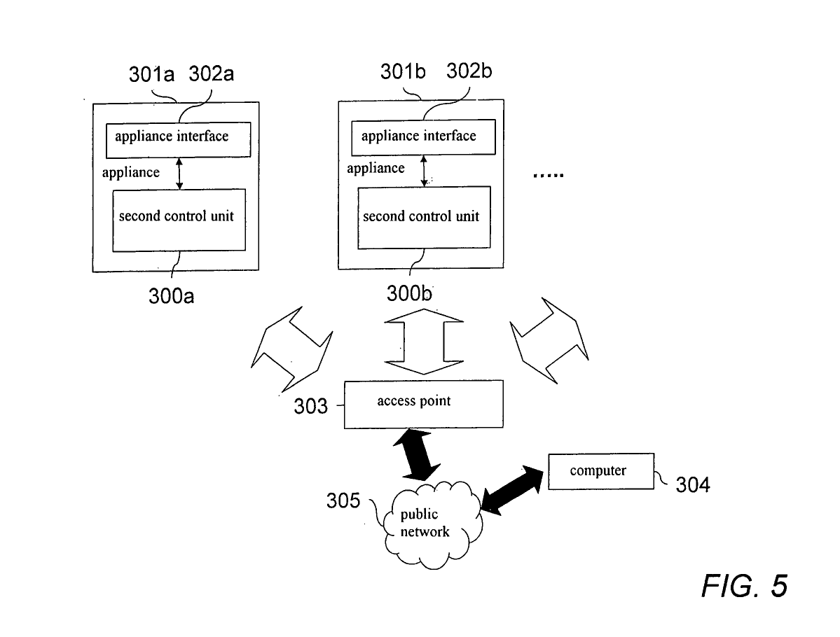

Referring to FIG. 5, according to a third embodiment of the present invention, the first control unit can be a computer 304, which can generate a data packet that complies with a standard wireless network communication protocol, such as 802.11 serial. The data packet can be wired or wirelessly transmitted to a public network 305 and then forwarded to an access point 303 so as to control the operation of the household appliances 301a and 301b. The public network may, for example, be an ADSL (asymmetric digital subscriber line) or a cable modem (cable TV).

The household appliances can be a TV, refrigerator, air conditioner, microwave oven, washing machine . . . etc.. Moreover, the first control unit can be a remote control, a computer mouse, a keyboard or the like.

While the description above refers to particular embodiments of the present invention, it will be understood that many modifications may be made without departing from the spirit thereof. The accompanying claims are intended to cover such modifications as would fall within the true scope and spirit of the present invention.

1. A wireless network controller for communicating with a household appliance, comprising:
a) a first control unit including a user interface, a processor, and a wireless transmitting module; wherein when a user operates the interface to supply a control signal to the processor, the processor formats the control signal into at least one data packet that complies with a standard wireless network communication protocol, and the wireless transmitting module sends the data packet wirelessly;
b) at least a second control unit coupled to the household appliance; wherein the second control unit including a user interface, a processor, and a wireless transmitting module; wherein the wireless transmitting module of the second control unit receives the at least one data packet and generates a control command so as to control an operation of the household appliance.

2. The controller as claimed in claim 1, wherein the standard wireless network communication protocol is an IEEE 802.11 serial protocol.

3. The controller as claimed in claim 1, wherein the second control unit receives a feedback signal from the household appliance, which can be further transmitted to the first control unit.

4. The controller as claimed in claim 1, wherein the second control unit further has a household appliance communication interface to couple with a household appliance control interface of the household appliance.

5. The controller as claimed in claim 2, wherein the data packet is transmitted in ad-hoc mode.

6. The controller as claimed in claim 1, wherein the data packet is transmitted to an access point, and then forwarded to the household appliance.

7. The controller as claimed in claim 6, wherein the access point wirelessly forwards the data packet.

8. The controller as claimed in claim 6, wherein the first control unit is a computer so as to generate and send the data packet to a public network; and wherein the access point receives the data packet from the public network.

9. The controller as claimed in claim 8, wherein the public network is an ADSL (asymmetric digital subscriber line) or a cable modem.

10. The controller as claimed in claim 1, wherein the wireless transmitting module includes a transmitting/receiving control unit, a transmitting unit, a receiving unit, and an antenna; and wherein the transmitting/receiving control unit controls the transmitting unit and antenna unit for sending signals, and the receiving unit and antenna unit for receiving signals.

11. The controller as claimed in claim 1, wherein the first control unit is a remote control.

12. The controller as claimed in claim 1, wherein the first control unit is a computer input device.

13. The controller as claimed in claim 11, wherein the user interface of the first control unit is a touch pad.

14. The controller as claimed in claim 1, wherein the second control is built-in the household appliance.

15. The controller as claimed in claim 14, wherein the user interface of the second control unit is a touch pad.

16. A method for controlling a household appliance, comprising the steps of:
using a first control unit to generate at least one data packet that complies with a standard wireless network communication protocol;
receiving and decoding the data packet by a second control unit which is respectively coupled to the household appliance;
in response to said data packet, sending a control command from the second control unit to the household appliance so as to control the operation of the household appliance.

17. The method as claimed in claim 16, wherein the standard wireless network communication protocol is an IEEE 802.11 serial protocol.
